(19) United States
(12) Patent Application Publication
(10) Pub. No.: US 2018/0342759 A1
(43) Pub. Date: Nov. 29, 2018

(54) LITHIUM-ION BATTERY CELL AND LITHIUM-ION BATTERY

(71) Applicant: Gree Electric Appliances, INC. of Zhuhai, Guangdong (CN)

(72) Inventors: Kuan Zhong, Guangdong (CN); Shiyong Jiang, Guangdong (CN); Wenhua Wang, Guangdong (CN); Ying Li, Guangdong (CN); Qianqian Li, Guangdong (CN); Hongming Liu, Guangdong (CN)

(21) Appl. No.: 15/779,384

(22) PCT Filed: Oct. 25, 2016
(86) PCT No.: PCT/CN2016/103256

§ 371 Date: May 25, 2018

(30) Foreign Application Priority Data
Nov. 30, 2015 (CN) 201510861234.X

(51) Int. Cl. H01M 10/0525; H01M 10/0587; H01M 2/30; H01M 10/04; H01M 4/02

(52) U.S. Cl. CPC H01M 10/0525; H01M 10/0587; H01M 2/30; H01M 2004/028; H01M 4/02; H01M 10/0459; H01M 10/0431

(57) ABSTRACT

A lithium-ion battery cell and a lithium-ion battery including the lithium-ion battery cell are provided. The lithium-ion battery cell includes a positive plate, a membrane and a negative plate. Multiple positive lugs are arranged sequentially on the positive plate in a unfolded state, multiple negative lugs are arranged sequentially on the negative plate in a unfolded state. The positive plate and the negative plate are separated by the membrane and are wound to form the lithium-ion battery cell. The multiple positive lugs form a lug laminated structure or a lug staggered structure, and the multiple negative lugs form a lug laminated structure or a lug staggered structure.

The present application claims priority to Chinese Patent Application No. 201510861234.X, titled “LITHIUM-ION BATTERY CELL AND LITHIUM-ION BATTERY”, filed on Nov. 30, 2015 with the State Intellectual Property Office of People's Republic of China, which is incorporated herein by reference in its entirety.

### FIELD

The present disclosure relates to the technical field of lithium-ion batteries, in particular to a lithium-ion battery cell and a lithium-ion battery.

### BACKGROUND

At present, clean and high-efficient energy conversion and storage devices such as lithium-ion batteries are widely used. Power lithium-ion batteries mainly include types of cylindrical, laminated aluminum plastic film, winding square (aluminum cased), laminated square and the like. A process for a cylindrical battery is mature, the cylindrical battery has a high consistency and may be designed to have a high rate. However, capacity of the cylindrical battery is small. In a case that the cylindrical battery is used in an electric vehicle, a large number of single batteries are required, a battery management module is complex, and a difference between two single batteries may lead to a reduced service life and a decreased performance of the battery module. A laminated battery has an advantage of a high rate performance. However, the process required by the laminated battery is relatively complex and the laminated battery is prone to self-discharge. A winding square battery may be designed to have a high capacity, while the rate performance is reduced. Furthermore, a battery with an aluminum plastic film case is prone to be deformed and destroyed by an external force. In the field of energy storage, it is intended to use a large-capacity single battery. An energy storage battery do not have a high requirement on the rate performance, in this case, aluminum cased batteries have advantages in this respect. However, for high-end energy storage products, a good rate performance is also required. Therefore, it is of great significance for application fields requiring high-capacity single batteries such as the electric vehicles field and the energy storage field to design a battery packaged in an aluminum case, which has a larger capacity and an improved rate performance.

In order to increase a power density of a lithium-ion battery, that is, to improve the rate performance of the battery, it is required to reduce an internal resistance of the battery, reduce polarization inside the battery and accelerate an output of current. An effective way to achieve these objects is to increase the number of lugs in the battery. The laminated battery is an effective selection for a high rate battery. The laminated battery has a superior rate performance and a large number of lugs due to the characteristics of lamination. However, for the battery with this structure, the preparation efficiency is low, a displacement is prone to occur between adjacent layers, and there is a large safety margin due to many burrs on an edge of a plate. In addition, the amount of self-discharge of the battery is large. For a winding lithium-ion battery, the number of lugs may be increased by increasing the number of cells connected in parallel, which may reduce capacity and the preparation efficiency of the battery, and may also affect the consistency of the battery. Therefore, a new lithium-ion battery is required.

### SUMMARY

In view of this, a lithium-ion battery cell and a lithium-ion battery are provided according to the present disclosure to solve the technical problems, the lithium-ion battery cell may have multiple positive lugs and multiple negative lugs, and the multiple positive lugs and the multiple negative lugs are wound to form the lithium-ion battery cell.

A lithium-ion battery cell is provided, which includes a positive plate, a membrane, and a negative plate. Multiple positive lugs are arranged sequentially on the positive plate in a unfolded state. Multiple negative lugs are arranged sequentially on the negative plate in a unfolded state. The positive plate and the negative plate are separated by the membrane and are wound to form the lithium-ion battery cell. The multiple positive lugs form a lug laminated structure or a lug staggered structure. The multiple negative lugs form a lug laminated structure or a lug staggered structure.

Furthermore, according to an embodiment of the present disclosure, multiple positive lugs are arranged in parallel in a direction along a length of the positive plate. A first lug margin x₁ indicates a distance between a first positive lug and a head of the positive plate. A distance between each of the positive lugs other than the first positive lug and the head of the positive plate is indicated by d₁, with d₁=n₁w−x₁+(0.5πtΣn₁−0.5πt) or d₁=n₃w+x₁+[0.57πtΣ(n₃+1)−0.5πt]. The lithium-ion battery cell is square, and the multiple positive lugs form the lug laminated structure. t indicates a sum of thicknesses of the positive plate, the membrane and the negative plate. w indicates a width of the cell. The first positive lug is the one of the positive lugs which is located closest to the head of the positive plate. n₁ indicates that a positive lug is located at the n₁-th w on the positive plate along a direction from the head to a tail of the positive plate. n₃ indicates that a positive lug is located at the (n₃+1)-th w on the positive plate along the direction from the head to the tail of the positive plate.

Furthermore, according to an embodiment of the present disclosure, the multiple negative lugs are arranged in parallel in a direction along a length of the negative plate. a second lug margin x₂ indicates a distance between a first negative lug and a head of the negative plate. A distance between each of the negative lugs other than the first negative lug and the head of the negative plate is indicated by d₂, with d₂=n₂w−x₂+(0.5πtΣn₂−0.5πt) or d₂=n₄w+x₂+[0.5πtΣ(n₄+1)−0.5πt]. The multiple negative lugs form the lug laminated structure. The first negative lug is the one of the negative lugs which is located closest to the head of the negative plate. n₂ indicates that a negative lug is located at the n₂-th w on the negative plate along a direction from the head to a tail of the negative plate. n₄ indicates that a negative lug is located at the (n₄+1)-th w on the negative plate along the direction from the head to the tail of the negative plate.

Furthermore, according to an embodiment of the present disclosure, the multiple positive lugs form the lug staggered structure, where d₁ of each of m₁ positive lugs in the multiple positive lugs is increased or decreased by a first interval value corresponding to the positive lug; and/or the multiple negative lugs form the lug staggered structure, where d₂ of each of m₂ negative lugs in the multiple negative lugs is increased or decreased by a second interval value corresponding to the negative lug.

Furthermore, according to an embodiment of the present disclosure, intervals between adjacent staggered positive lugs in the m₁ positive lugs are the same.

Furthermore, according to an embodiment of the present disclosure, starting from the first one in the m₁ positive lugs, d₁ of each of the m₁ positive lugs is decreased by a first interval value mq, where d₁=n₁w−x₁+(0.5πtΣn₁−0.5πt), q indicates an interval between two adjacent staggered positive lugs, m indicates a sequence number of a positive lug in the m₁ positive lugs along a direction from the head to the tail of the positive plate, 1≤m≤m₁.

Furthermore, according to an embodiment of the present disclosure, starting from the first one in the m₁ positive lugs, d₁ of each of the m₁ positive lugs is increased by a first interval value mq; where d₁=n₃w−x₁+[0.5πtΣ(n₃+1)−0.5πt], q indicates an interval between two adjacent staggered positive lugs, m indicates a sequence number of a positive lug in the m₁ positive lugs along a direction from the head to tail of the positive plate 1≤m≤m₁.

Furthermore, according to an embodiment of the present disclosure, intervals between adjacent staggered negative lugs in the m₂ negative lugs are the same.

Furthermore, according to an embodiment of the present disclosure, starting from the first one in the m₂ negative lugs, d₂ of each of the m₂ negative lugs is decreased by a first interval value mq; where d₂=n₄w+x₂+[0.5πtΣ(n₄+1)−0.5πt], q indicates an interval between two adjacent staggered negative lugs, m indicates a sequence number of a negative lug in the m₂ negative lugs along a direction from the head to the tail of the negative plate, 1≤m≤m₂.

Furthermore, according to an embodiment of the present disclosure, starting from the first one in the m₂ negative lugs, d₂ of each of the m₂ negative lugs is increased by a the first interval value mq; where d₂=n₄w+x₂+[0.5πtΣ(n₄+1)−0.5πt], q indicates an interval between two adjacent staggered negative lugs, m indicates a sequence number of a negative lug in the m₂ negative lugs along a direction from the head to the tail of the negative plate, 1≤m≤m₂.

Furthermore, according to an embodiment of the present disclosure, the first lug margin x₁ is less than or equal to 0.5w, and the second lug margin x₂ is less than or equal to 0.5w.

Furthermore, according to an embodiment of the present disclosure, the width w of the cell is greater than or equal to 5 cm and is less than or equal to 20 cm.

Furthermore, according to an embodiment of the present disclosure, a distance between the tail of the positive plate and a positive lug closest to the tail of the positive plate is less than 8w, and a distance between the tail of the negative plate and a negative lug closest to the tail of the negative plate is less than 8w.

Furthermore, according to an embodiment of the present disclosure, the positive lug is made of aluminum or aluminum-nickel alloy, and the negative lug is made of nickel, copper or copper-nickel alloy.

Furthermore, according to an embodiment of the present disclosure, the multiple positive lugs are welded together by using ultrasonic; and the multiple negative lugs are welded together by using ultrasonic.

Furthermore, according to an embodiment of the present disclosure, the positive plate is coated with positive electrode slurry which is made by mixing a positive electrode powder, a conductive agent, an adhesive and an additive, and the negative plate is coated with negative electrode slurry which is made by mixing a negative electrode powder, a conductive agent, an adhesive and an additive.

A lithium-ion battery is provided, which includes a battery case and the above-described lithium-ion battery cell in the battery case.

Furthermore, according to an embodiment of the present disclosure, the battery case is made of aluminum.

With the lithium-ion battery cell and the lithium-ion battery according to the present disclosure, the rate performance of the battery is improved, and the consistency of the battery cell is improved, thereby facilitating grouping and modularized expansion, thus ensuring a stable operation and prolonging the service life. In addition, the safety performance and the production efficiency are improved, occurrence of burrs at the edge of the plate and the self-discharging rate are reduced, thereby improving stability of the battery.

### BRIEF DESCRIPTION OF THE DRAWINGS

In order to more clearly describe the technical solution in the embodiments of the present disclosure or the technical solution in the conventional technology, drawings to be used in the embodiments of the present disclosure or in the conventional technology are briefly described hereinafter. It is apparent that the drawings described below show merely the embodiments of the present disclosure, and those skilled in the art may obtain other drawings according to the provided drawings without any creative effort.

FIG. 1A and FIG. 1B are schematic diagrams respectively showing a positive plate in a unfolded state and a negative plate in a unfolded state of a lithium-ion battery cell according to the present disclosure, where FIG. 1A shows a positive plate, and FIG. 1B shows a negative plate;

FIG. 2A and FIG. 2B are schematic diagrams respectively showing a positive plate in a unfolded state and a negative plate in a unfolded state of another lithium-ion battery cell according to the present disclosure, where FIG. 2A shows a positive plate, and FIG. 2B shows a negative plate;

FIG. 3 is a schematic diagram showing a lithium-ion battery cell according to an embodiment of the present disclosure;

FIG. 4 is a schematic diagram showing a lithium-ion battery cell according to another embodiment of the present disclosure;

FIG. 5 is a schematic diagram showing coating and positions of lugs of a lithium-ion battery cell according to the present disclosure;

FIG. 6 is a diagram showing plate coating and lug distribution of a lithium-ion battery cell according to the present disclosure;

FIG. 7 is a diagram showing arrangement of a plate with an interval of 0.5 cm between two positive lugs of a lithium-ion battery cell according to the present disclosure;

FIG. 8 is a diagram showing arrangement of a negative plate with three lugs of a lithium-ion battery cell according to the present disclosure; and

FIG. 9 is a diagram showing arrangement positions of lugs with an laminated structure and a staggered structure of the lithium-ion battery cell according to the present disclosure.

### DETAILED DESCRIPTION OF EMBODIMENTS

The present disclosure is described more fully hereinafter with reference to the drawings, in which exemplary embodiments of the present disclosure are described. The technical solutions in the embodiments of the present disclosure are described clearly and completely in conjunction with the accompanying drawings in the embodiments of the present disclosure hereinafter. It is apparent that the below-described embodiments are merely some rather than all of embodiments of the present disclosure. All other embodiments obtained by those skilled in the art based on the embodiments in the present disclosure without any creative work should fall within the protection scope of the present disclosure. The technical solutions of the present disclosure are described in various aspects with reference to the drawings and the embodiments.

Hereinafter, for convenience of description, the terms “left”, “right”, “upper” and “lower” in the following description are consistent with the left, right, upper, and lower directions of the drawings themselves. The terms “front end”, “back end” or “tail end” and the like means the left and right side of the figure itself. In the present disclosure, the words “first”, “second” and the like are only used to distinguish in description and have no other special meanings.

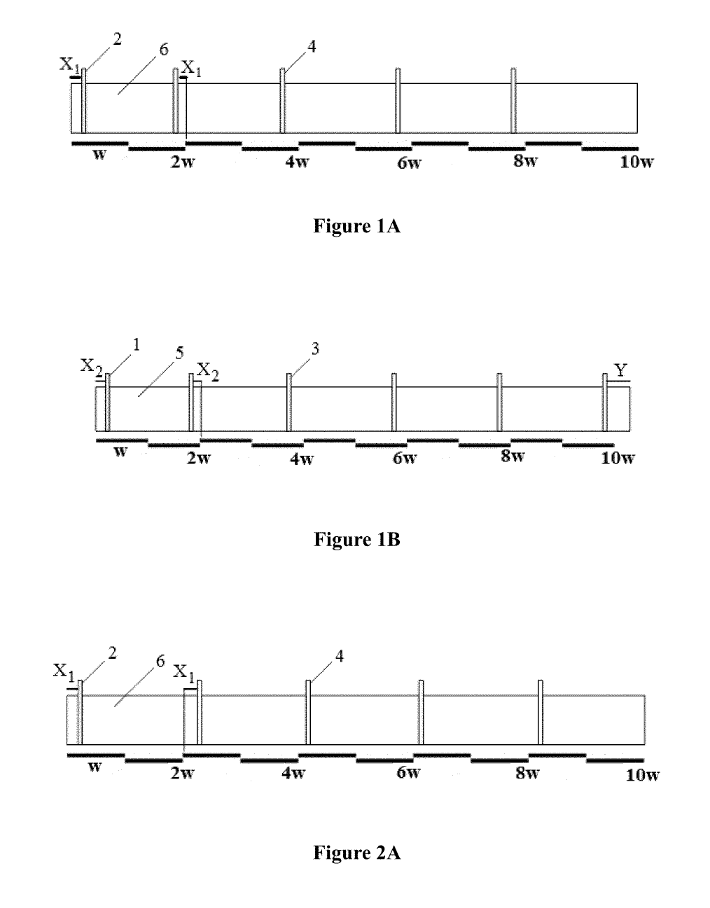

As shown in FIG. 1A to FIG. 4, a lithium-ion battery cell is provided according to the present disclosure. Multiple positive lugs are arranged sequentially on a positive plate in an unfolded state. Multiple negative lugs are arranged sequentially on a negative plate in an unfolded state. The positive plate and the negative plate are separated by a membrane and are wound to form the lithium-ion battery cell through a winding manner. The multiple positive lugs may form a lug laminated structure or a lug staggered structure. The multiple negative lugs may form a lug laminated structure or a lug staggered structure. The multiple positive lugs and the multiple negative lugs may be located at one end of the lithium-ion battery cell, and may also be respectively located at two ends of the lithium-ion battery cell.

The lithium-ion battery cell according to the present disclosure is provided with at least one positive lug and at least one negative lug, such that the battery has a good large-current discharge performance, the density of the lugs may be determined according to actual needs. A multiple-lugs wound design is adopted rather than a laminated design, thereby greatly reducing occurrence of burrs at the edge of the plate and reducing the self-discharge rate, thus improving the stability of the battery.

In an embodiment, as shown in FIG. 1A, the multiple positive lugs are arranged in parallel in a direction along a length of the positive plate 6. A first lug margin x₁ indicates a distance between a first positive lug 2 and a head of the positive plate 6. The head of the positive plate 6 indicates the left end of the positive plate 6, and the first positive lug 2 is located closet to the head of the positive plate 6. Generally, the lugs are not arranged at the leftmost or rightmost of the cell, and lug margins are provided to facilitate package of the cell and prevent occurrence of short circuits. The lug margin indicates a distance from the lug to the edge of the cell.

A distance between each of the multiple positive lugs other than the first positive lug and the head of the positive plate 6 is indicated by d₁, where d₁=n₁w−x₁+(0.5πtΣn₁−0.5πt). t indicates a sum of thicknesses of the positive plate, the membrane and the negative plate, that is, a minimum thickness of the winding. w indicates a width of the cell, that is, a width of the innermost layer of the cell. n₁ indicates that a positive lug is located at the n₁-th w on the positive plate along a direction from the head to a tail of the positive plate 6, where n₁≥2.

For example, in a case of calculating d₁ of the positive lug 4, n₁ is 4, the positive lug 4 is located at the fourth w on the positive plate 6, where d₁=4w−x₁+(0.5πtΣ4−0.5πt) and Σ4=1+2+3+4=10. Values of other parameters are substituted into the equation, to calculate d₁ of the positive lug 4, and d₁ of each of other positive lugs may be calculated by analogy.

As shown in FIG. 1B, the multiple negative lugs are arranged in parallel in a direction along a length of the negative plate 5. A second lug margin x₂ indicates a distance between a first negative lug 1 and the head of the negative plate 5. A distance between each of the multiple negative lugs other than the first negative lug and the head of the negative plate 5 is indicated by d₂, where d₂=n₂w−x2+(0.5πtΣn₂−0.5πt). n₂ indicates that a negative lug is located at the n₂-th w on the negative plate 5 along a direction from a head to a tail of the negative plate 5, where n₂≥2.

For example, in a case of calculating d₂ of the negative lug 3, n₂ is 4, the negative lug 3 is located at the fourth w on the negative plate 5, where d₂=4w−x₂+(0.5πtΣ4−0.5πt) and Σ4=1+2+3+4=10. Values of other parameters are substituted into the equation, to calculate d₂ of the negative lug 3, and d₂ of each of other negative lugs may be calculated by analogy.

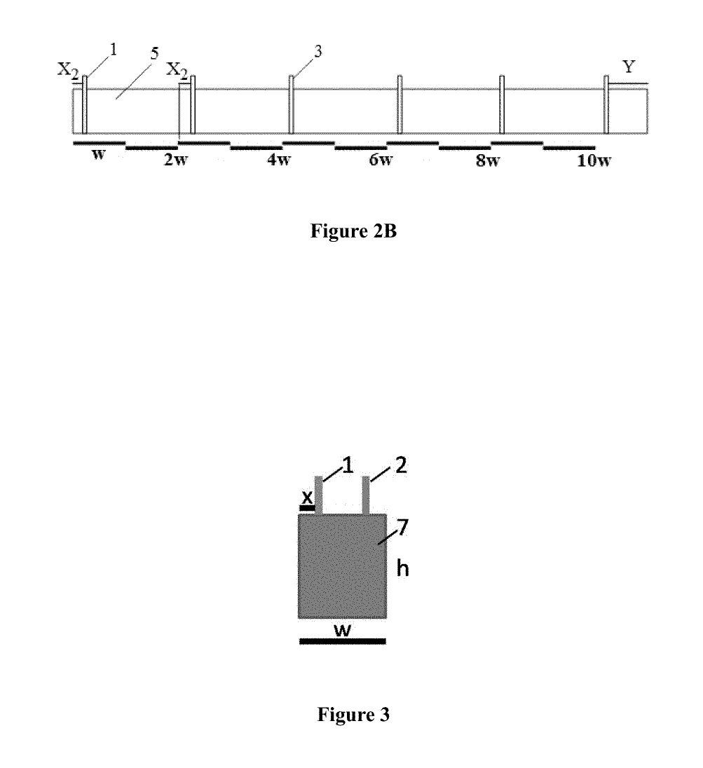

In an embodiment, as shown in FIG. 2A, the multiple positive lugs are arranged in parallel in a direction along the length of the positive plate 6, and the first lug margin x₁ indicates the distance between the first positive lug 2 and the head of the positive plate 6. The distance between each of the multiple positive lugs other than the first positive lug and the head of the positive plate 6 is indicated by d₁, where d₁=n₃w−x₁+[0.5πtΣ(n₃+1)−0.5πt]. n₃ indicates that a positive lug is located at the (n₃+1)-th w on the positive plate 6 along the direction from the head to the tail of the positive plate 6.

For example, in a case of calculating d₁ of the positive lug 4, n₃ is 4, the positive lug 4 is located at the fifth w on the positive plate, where d₁=4w+x₁+[0.5πtΣ(4+1)−0.5πt] and Σ4=1+2+3+4=10. Values of other parameters are substituted into the equation, to calculate d₁ of the positive lug 4, and d₁ of each of other positive lugs may be calculated by analogy.

As shown in FIG. 2B, the multiple negative lugs are arranged in parallel in a direction along a length of the negative plate 5. A second lug margin x₂ indicates a distance between the first negative lug 1 and the head of the negative plate 5. A distance between each of the multiple negative lugs other than the first negative lug and the head of the negative plate 5 is indicated by d₂, where d₂=n₄w+x₂+[0.5πtΣ(n₄+1)−0.5πt]. n₄ indicates that a negative lug is located at the (n₄+1)-th w on the negative plate 5 along the direction from the head to the tail of the negative plate 5.

For example, in a case of calculating d₂ of the negative lug 3, n₄ is 4, the negative lug 3 is located at the fifth w on the negative plate 5, where d₂=4w+x₁+[0.5πtΣ(4+1)−0.5πt] and Σ4=1+2+3+4=10. Values of other specific parameters are substituted into the equation, to calculate d₂ of the negative lug 3, and d₂ of each of other negative lugs may be calculated by analogy.

The lithium-ion battery cell is square, and a membrane is arranged between the positive plate 6 and the negative plate 5, two or more layers of the membranes may be arranged. After the lithium-ion battery cell 7 is formed by winding with a winding pin, the multiple positive lugs may form a lug laminated structure and the multiple negative lugs may form a lug laminated structure. As shown in FIG. 3, after the winding, the positive lugs are neatly laminated at one end of the cell 7, and the negative lugs are neatly laminated at the same end of the cell 7 as the positive lugs, where x indicates the lug margin.

The first lug margin x₁ and the second lug margin x₂ may be the same or different. The first lug margin x₁ is less than or equal to 0.5w, and the second lug margin x₂ is less than or equal to 0.5w. w indicates a width of the cell, and the width w of the cell is greater than or equal to 5 cm and less than or equal to 20 cm. h indicates a height, a range of h is 5 cm≤h≤20 cm. A cell thickness is indicated by d, and a range of d is 0.5 cm≤d≤5 cm. A length L1 of the negative plate and a length L2 of the positive plate meet 10w≤L1,L2≤200w. y indicates a length of the tail, where 0≤y<8w.

The lithium-ion battery cell in the above embodiment adopts a winding manner. After the first lug is arranged, positions of the second lug and subsequent lugs may be calculated through the equation nw−x+(0.5πtΣn−0.5πt) or nw+x+[0.5πtΣ(n+1)−0.5πt].

The above two equations are used to calculate the positions of the second and subsequent positive and negative lugs. During calculating a specific position, x is replaced by x₁ or x₂, and n is replaced by n₁, n₂, n₃ or n₄. A position of a lug calculated through nw+x+[0.5πtΣ(n+1)−0.5πt is behind the n-th w, and a position of a lug calculated through nw−x+(0.5πtΣn−0.5πt) is in front of the (n+1)-th w.

In an embodiment, a current collector of the positive plate is aluminum foil, and a current collector of the negative plate is copper foil. The aluminum foil is continuously and uniformly coated with positive electrode slurry containing a lithium-ion active material to form the positive plate, and the copper foil is continuously and uniformly coated with negative electrode slurry containing a lithium-ion active material to form the negative plate. Uncoated regions are reserved on the coated sides of the positive and negative plates for arranging the positive and negative lugs respectively. After the winding, two or more lugs are welded together by using ultrasonic, or the lugs are directly welded to a transition metal plate, and the transition metal plate is welded to a top cover of the battery case subsequently.

The cell is formed with a winding manner by welding multiple lugs, such that the rate performance of a large and medium-sized lithium-ion battery is improved, and good consistency and stability of the battery can be obtained, thereby facilitating grouping and modularized expansion, thus ensuring a stable operation of the system and prolonging a service life of the system.

After the positions of the lugs are calculated through the above equations, the lugs are moved forward or backward by a certain distance to form a lug staggered structure. d₁ of each of the m₁ positive lugs in the multiple positive lugs is increased or decreased by a first interval value corresponding the positive lug, such that the multiple positive lugs form a lug staggered structure. That is, there are m₁ positive lugs being staggered in the multiple laminated positive lugs, where m₁ may be 1, 2, 3 and the like. Intervals between adjacent staggered positive lugs may be the same or different.

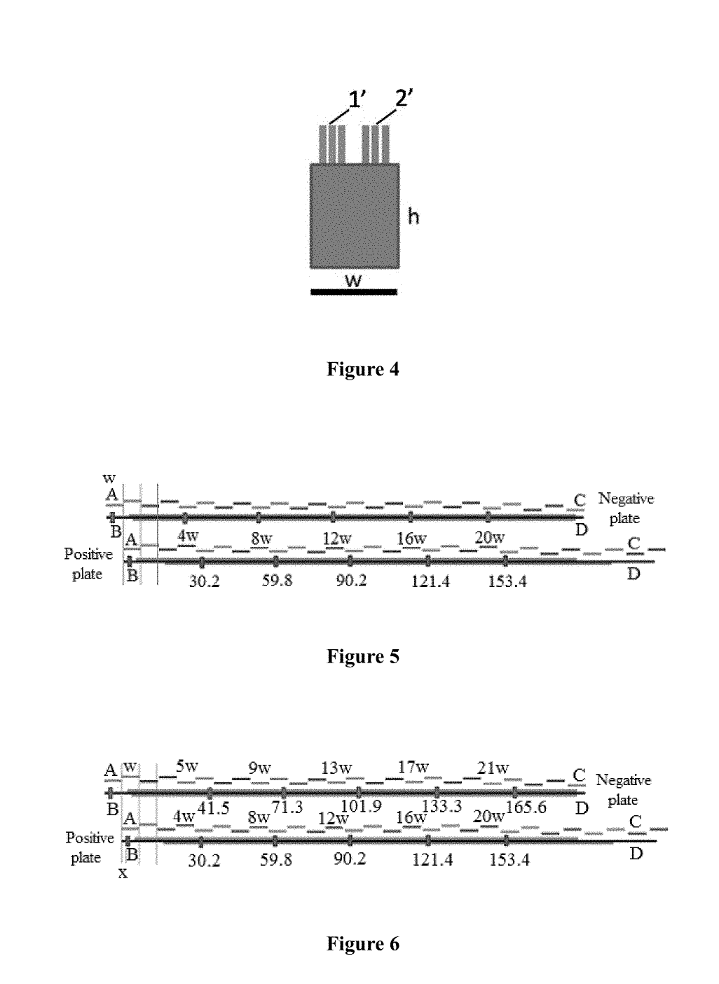

The multiple negative lugs may form a lug staggered structure. d₂ of each of the m₂ negative lugs in the multiple negative lugs is increased or decreased by a second interval value corresponding the negative lug, such that there are m₂ negative lugs being staggered in the multiple laminated negative lugs, where m₂ may be 1, 2, 3 and the like. Intervals between adjacent staggered negative lugs may be the same or different. For example, the arrangement 1′ of the negative electrode and the arrangement 2′ of the positive electrode in FIG. 4 are in a staggered manner.

In an embodiment, the intervals between adjacent staggered positive lugs in the m₁ positive lugs are the same. Starting from the first one in the m₁ positive lugs, d₁ of each of the m₁ positive lugs is decreased by a first interval value mq. Where d₁=n₁w−x₁+(0.5πtΣn₁−0.5πt), q indicates an interval between two adjacent staggered positive lugs, and m indicates a sequence number of a positive lug in the m₁ positive lugs along a direction from the head to the tail of the positive plate, where 1≤m≤m₁.

Alternatively, starting from the first one in the m₁ positive lugs, d₁ of each of the m₁ positive lugs is increased by a first interval value mq. Where d₁=n₃w−x₁+[0.5πtΣ(n₃+1)−0.5πt], q indicates an interval between two adjacent staggered positive lugs, m indicates a sequence number of a positive lug in the m₁ positive lugs along a direction from the head to the tail of the positive plate, where 1≤m≤m₁.

The intervals between adjacent staggered negative lugs in the m₂ negative lugs are the same. Starting from the first one in the m₂ negative lugs, d₂ of each of the m₂ negative lugs is decreased by a first interval value mq. Where d₂=n₂w−x₂+(0.5πtΣn₂−0.5πt), q indicates an interval between two adjacent staggered negative lugs, m indicates a sequence number of a negative lug in the m₂ negative lugs along a direction from the head to the tail of the negative plate, where 1≤m≤m₂.

Alternatively, starting from the first one in the m₂ negative lugs, d₂ of each of the m₂ negative lugs is increased by a first interval value mq. Where d₂=n₄w+x₂+[0.5πtΣ(n₄+1)−0.5πt], q indicates an interval between two adjacent staggered negative lugs, m indicates a sequence number of a negative lug in the m₂ negative lugs along a direction from the head to the tail of the negative plate, where 1≤m≤m₂.

A case where the lugs of the lithium-ion battery cell are laminated meets the following equations nw+x+[0.5πtΣ(n+1)−0.5πt and nw−x+(0.5πtΣn−0.5πt). Based on the above two equations, the lugs are moved forward or backward by a certain distance. Starting from the first one in the lugs with incremented sequence numbers, a position of the lug is moved inward or outward by mq, where m=1, 2, 3, . . . . For the first lug, m=1, for the second lug, m=2, and for other cases, m may be determined by analogy, where q indicates an interval between two lugs (0<q<5 cm).

The lugs are staggered and an interval between two adjacent lugs is indicated by q. If the first lug is in the middle, a lug on the left is moved outward by q, and a lug on the right is moved inward by q. For the lugs whose positions are calculated through nw−x+(0.5πtΣn−0.5πt), since the lugs are located behind the nw, it is required to moved forward the lugs starting from the second lug. For the lugs whose positions are calculated through nw+x+[0.5πtΣ(n+1)−0.5πt], since the lugs are located in front of the (n+1)w, it is required to move backward the lugs starting from the second lug.

A lithium-ion battery is further provided according to the present disclosure, which includes a battery case and the lithium-ion battery cell as described above located in the battery case. The negative lugs and the positive lugs are located on the same side of the battery cell, the positive and negative lugs may be connected to an electrode pillar of the battery case by a bolt or through a riveting process. The battery case is made of aluminum.

The positive plate is coated with positive electrode slurry, the positive electrode slurry is made by mixing a positive electrode powder, a conductive agent, an adhesive and an additive. The negative plate is coated with negative electrode slurry, the negative electrode slurry is made by mixing a negative electrode powder, a conductive agent, an adhesive and an additive. In order to avoid occurrence of lithium precipitation at a negative electrode due to a positive electrode corresponding to a negative lug, in addition to coating a glue to protect the negative lug, the performance of the slurry is improved to avoid the occurrence of lithium precipitation.

In an embodiment, both thicknesses of a side wall and a front wall of the aluminum case are 0.3 mm. A thickness of a bottom is 0.6 mm. A thickness d of the cell is designed to be 0.82 cm. A width of the positive plate is 14 cm. A width of the negative plate is 14.2 cm. A width of the membrane is 14.5 cm.

The positive active material is a ternary material and has a specific capacity of 150 mAh/g. The negative active material is artificial graphite or composite graphite, and has a specific capacity of 345 mAh/g, and a capacity of the negative electrode is excessive by 4%. The composition of the positive electrode slurry is: 95.5% of the ternary material, 2% of the adhesive, 1.5% of the conductive agent and 1% of a nano inorganic functional additive. The compacted density is 3.6 g/cm³, a thickness of a single-layer coating is 0.064 mm, the surface density is 461 g/m², a thickness of the current collector aluminum foil is 0.012 mm, and the calculated unit capacity is 7.224 mAh/cm².

The composition of the negative electrode slurry is: 95.5% of the ternary material, 1.2% of a thickener, 1.5% of the adhesive, 1% of the conductive agent and 0.8% of a nano inorganic functional additive. The compacted density is 1.5 g/cm³, a thickness of a single-layer coating is 0.070 mm, a surface density is 224 g/m², a thickness of the current collector aluminum foil is 0.009 mm, and the calculated unit capacity is 7.4 mAh/cm². t is 0.33 mm.

Based on the thicknesses of the cell, the positive and negative plates and the membrane, a length of a plate with a coating is 175 cm, specific coating sizes are shown in the following table 1, and the capacity of the battery is 35 Ah. The schematic diagram of coating is as shown in FIG. 5, where x is set to 1.5 cm, a width of the lug is 1.5 cm, and w is calculated as 7 cm (a width of the innermost unit roll layer after the winding pin is pulled out).

TABLE 1
list of coating sizes of the positive and negative plates

| | | | | | Total length of |
|---|---|---|---|---|---|
| | A | B | C | D | the plate |
| Negative plate | 8 | 11.5 | 3 | 3 | 188 |
| Positive plate | 4.7 | 14.8 | 28 | 14.4 | 205.9 |

In order to design a lug laminated structure, the positive and negative plates are respectively provided with six lugs. Positions of the lugs may be calculated through the following equation nw+x+[0.5πtΣ(n+1)−0.5πt]. The calculated positions of the lugs are as shown in FIG. 5 (the interval between the positive lugs is the same as the interval between the negative lugs). The lugs may be directly welded to the aluminum cover, or may be first welded to a large transition metal plate, and the transition metal plate is welded to the aluminum cover.

In order to avoid occurrence of lithium precipitation of a negative lug, in addition to coating a glue to protect the negative lug, the performance of the slurry is improved to avoid the occurrence of lithium precipitation. A highly wet negative active material such as a lightly oxidized graphite material may be used. A silicon carbon negative electrode material may be used, which has a certain absorption effect on increase of the capacity.

In an embodiment, the positions of the positive lugs are the same as the positions of the positive lugs in FIG. 5, and the positions of the negative lugs are set according to the following equation nw−x+(0.5πtΣn−0.5πt), which are as shown in FIG. 6.

In an embodiment, the lugs of the lithium-ion battery cell are staggered, each of the positive plate and negative plate is provided with two lugs, where an interval between the lugs is 0.5 cm. for a case where the lugs are distributed based on the following equation nw−x+(0.5πtΣn−0.5πt), a staggered arrangement is formed by moving one of the lugs forward by 0.5 cm, where intervals between the staggered lugs are the same.

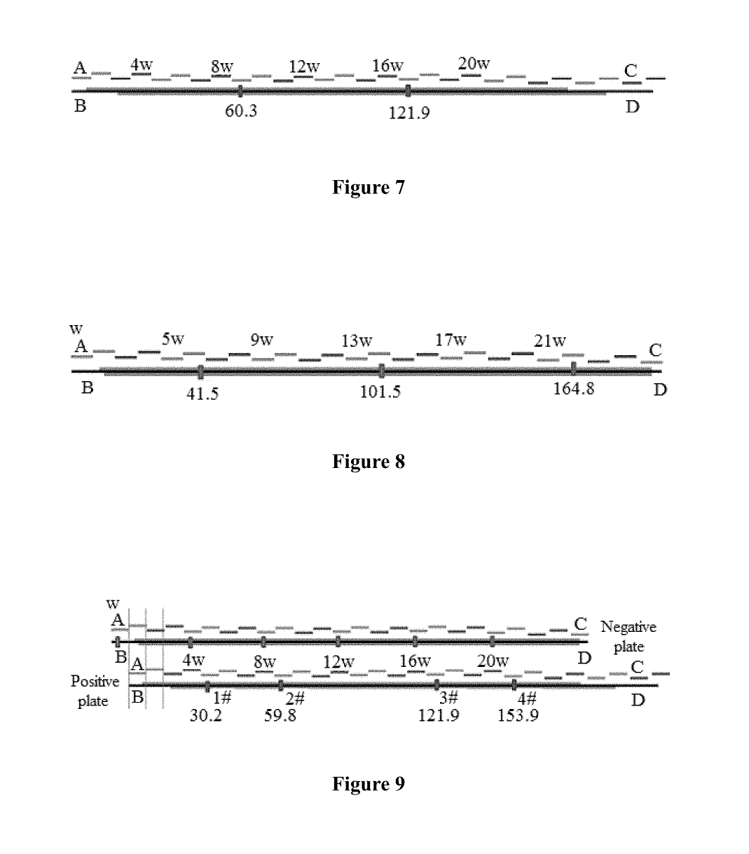

For a case where the lugs are distributed based on the following equation nw+x+[0.5πtΣ(n+1)−0.5πt], a staggered arrangement is formed by moving one of the lugs backward by 0.5 cm. For example, for a positive lug with a position calculated through nw+x+[0.5πtΣ(n+1)−0.5πt], if n=8, the lug is at a position of 60.3 cm; if n=16, the lug is at a position of 121.9 cm, the positions of the lugs are as shown in FIG. 7.

In an embodiment, the lugs of the lithium-ion battery cell are staggered. Each of the positive plate and negative plate is provided with three lugs, where each lug has a width of 1 cm, and intervals of the staggered lugs are 0.4 cm. For the negative plate in which a position of a lug is calculated through the following equation nw−x+(0.5πtΣn−0.5πt), the first lug is at a position of n=6. The next lug is at a position moved forward by 0.4 cm from a position of n=14. The third lug is at a position moved forward by 0.8 cm from a position of n=22. The positions of the negative lugs are as shown in FIG. 8. The positions of the positive lugs are similar to that of the negative lugs.

In an embodiment, the lugs of the lithium-ion battery cell have a lug laminated structure or a lug staggered structure. Two groups of lugs are laminated, and intervals between the staggered lugs are 0.5 cm. The laminated lugs are located at positions calculated through the following equation nw+x+[0.5πtΣ(n+1)−0.5πt], and the staggered lugs are located at positions calculated through the following equation nw+x+[0.5πtΣ(n+1)−0.5πt]+0.5. As shown in FIG. 9, n for the laminated lugs are 4 and 8 (corresponding to positions of 30.2 cm and 59.8 cm), and n for another group of the laminated lugs are 16 and 20 (corresponding to positions of 121.9 cm and 153.9 cm). In other words, the laminated lugs are located at positions calculated through the following equation nw−x+(0.5πtΣn−0.5πt), and the staggered lugs are located at positions calculated through the following equation nw−x+(0.5πtΣn−0.5πt)−0.5.

In the above embodiments, the lithium-ion battery cell and the lithium-ion battery adopt a multi-lug design, which greatly improves the rate performance of the battery. With the multi-lug design based on the winding manner, the consistency of the cell is improved, thereby facilitating grouping and modularized expansion, thus ensuring the stable operation of the system and prolonging the service life of the system. In order to avoid the complicated process of blanking a region on the positive region corresponding to the negative lug, a simple method of improving the composition of the slurry is adopted, thereby avoiding the occurrence of lithium precipitation at the negative electrode, thus improving the production efficiency while improving the safety performance. The winding multi-lug design is adopted instead of the laminated design, thereby greatly reducing the occurrence of burrs at the edge of the plate and reducing the self-discharging rate, thus improving the stability of the battery.

The method and the system of the present disclosure may be implemented in many ways. For example, the method and the system of the present disclosure may be implemented by software, hardware, firmware or any combination of the software, the hardware and the firmware. The above sequence of steps used in the method is only for illustration, and the steps of the method of the present disclosure are not limited to the above-described specific order unless otherwise specified. In addition, in some embodiments, the present disclosure may also be implemented as programs recorded in a recording medium, the programs include machine-readable instructions for implementing the method according to the present disclosure. Thus, the present disclosure also covers a recording medium storing a program for executing the method according to the present disclosure.

The description of the present disclosure is presented for illustration and description, but is not intended to be exhaustive or limit the disclosure to the forms disclosed. Many modifications and variations are apparent to those skilled in the art. The embodiments were chosen and described to best explain the principles and the practical applications of the disclosure, and to enable those skilled in the art to understand the disclosure to design various embodiments with various modifications that are applicable to particular uses.

1. A lithium-ion battery cell, comprising:
a positive plate;
a membrane; and
a negative plate, wherein
a plurality of positive lugs is arranged sequentially on the positive plate in a unfolded state, a plurality of negative lugs is arranged sequentially on the negative plate in a unfolded state, and
the positive plate and the negative plate are separated by the membrane and are wound to form the lithium-ion battery cell, the plurality of positive lugs forms a lug laminated structure or a lug staggered structure, and the plurality of negative lugs forms a lug laminated structure or a lug staggered structure.

2. The lithium-ion battery cell according to claim 1, wherein
the plurality of positive lugs is arranged in parallel in a direction along a length of the positive plate;
a first lug margin x₁ indicates a distance between a first positive lug and a head of the positive plate, a distance between each of the positive lugs other than the first positive lug and the head of the positive plate is indicated by d₁, with d₁=n₁w−x₁+(0.5πtΣn₁−0.5πt) or d₁=n₃w−x₁+[0.5πtΣ(n₃+1)−0.5πt];
the lithium-ion battery cell is square, and the plurality of positive lugs forms the lug laminated structure;
where t indicates a sum of thicknesses of the positive plate, the membrane and the negative plate, w indicates a width of the cell, the first positive lug is the one of the positive lugs which is located closest to the head of the positive plate, n₁ indicates that a positive lug is located at the n₁-th w on the positive plate along a direction from the head to a tail of the positive plate, and n₃ indicates that a positive lug is located at the (n₃+1)-th w on the positive plate along the direction from the head to the tail of the positive plate.

3. The lithium-ion battery cell according to claim 2, wherein
the plurality of negative lugs is arranged in parallel in a direction along a length of the negative plate;
a second lug margin x₂ indicates a distance between a first negative lug and a head of the negative plate, a distance between each of the negative lugs other than the first negative lug and the head of the negative plate is indicated by d₂, with d₂=n₂w−x₂+(0.5πtΣn₂−0.5πt) or d₂=n₄w+x₂+[0.5πtΣ(n₄+1)−0.5πt];
the plurality of negative lugs forms the lug laminated structure;
the first negative lug is the one of the negative lugs which is located closest to the head of the negative plate;
where n₂ indicates that a negative lug is located at the n₂-th w on the negative plate along a direction from the head to a tail of the negative plate, and n₄ indicates that a negative lug is located at the (n₄+1)-th w on the negative plate along the direction from the head to the tail of the negative plate.

4. The lithium-ion battery cell according to claim 3, wherein
the plurality of positive lugs forms the lug staggered structure, wherein d₁ of each of m₁ positive lugs in the plurality of positive lugs is increased or decreased by a first interval value corresponding to the positive lug; and/or
the plurality of negative lugs forms the lug staggered structure, wherein d₂ of each of m₂ negative lugs in the plurality of negative lugs is increased or decreased by a second interval value corresponding to the negative lug.

5. The lithium-ion battery cell according to claim 4, wherein intervals between adjacent staggered positive lugs in the m₁ positive lugs are the same.

6. The lithium-ion battery cell according to claim 5, wherein
starting from the first one in the m₁ positive lugs, d₁ of each of the m₁ positive lugs is decreased by a first interval value mq;
wherein d₁=n₁w−x₁+(0.5πtΣn₁−0.5πt), q indicates an interval between two adjacent staggered positive lugs, m indicates a sequence number of a positive lug in the m₁ positive lugs along a direction from the head to the tail of the positive plate, 1≤m≤m₁.

7. The lithium-ion battery cell according to claim 5, wherein
starting from the first one in the m₁ positive lugs, d₁ of each of the m₁ positive lugs is increased by a first interval value mq;
wherein d₁=n₃w−x₁+[0.5πtΣ(n₃+1)−0.5πt], q indicates an interval between two adjacent staggered positive lugs, m indicates a sequence number of a positive lug in the m₁ positive lugs along a direction from the head to tail of the positive plate 1≤m≤m₁.

8. The lithium-ion battery cell according to claim 4, wherein intervals between adjacent staggered negative lugs in the m₂ negative lugs are the same.

9. The lithium-ion battery cell according to claim 8, wherein
starting from the first one in the m₂ negative lugs, d₂ of each of the m₂ negative lugs is decreased by a first interval value mq;
wherein d₂=n₂w−x₂+(0.5πtΣn₂−0.5πt), q indicates an interval between two adjacent staggered negative lugs, m indicates a sequence number of a negative lug in the m₂ negative lugs along a direction from the head to the tail of the negative plate, 1≤m≤m₂.

10. The lithium-ion battery cell according to claim 8, wherein
starting from the first one in the m₂ negative lugs, d₂ of each of the m₂ negative lugs is increased by the first interval value mq;
wherein d₂=n₄w+x₂+[0.5πtΣ(n₄+1)−0.5πt], q indicates an interval between two adjacent staggered negative lugs, m indicates a sequence number of a negative lug in the m₂ negative lugs along a direction from the head to the tail of the negative plate, 1≤m≤m₂.

11. The lithium-ion battery cell according to claim 3, wherein
the first lug margin x₁ is less than or equal to 0.5w; and
the second lug margin x₂ is less than or equal to 0.5w.

12. The lithium-ion battery cell according to claim 3, wherein the width w of the cell is greater than or equal to 5 cm and is less than or equal to 20 cm.

13. The lithium-ion battery cell according to claim 3, wherein
a distance between the tail of the positive plate and a positive lug closest to the tail of the positive plate is less than 8w; and
a distance between the tail of the negative plate and a negative lug closest to the tail of the negative plate is less than 8w.

14. The lithium-ion battery cell according to claim 1, wherein
the positive lug is made of aluminum or aluminum-nickel alloy; and
the negative lug is made of nickel, copper or copper-nickel alloy.

15. The lithium-ion battery cell according to claim 1, wherein
the plurality of positive lugs is welded together by using ultrasonic; and
the plurality of negative lugs is welded together by using ultrasonic.

16. The lithium-ion battery cell according to claim 1, wherein
the positive plate is coated with positive electrode slurry which is made by mixing a positive electrode powder, a conductive agent, an adhesive and an additive; and
the negative plate is coated with negative electrode slurry which is made by mixing a negative electrode powder, a conductive agent, an adhesive and an additive.

17. A lithium-ion battery, comprising a battery case and a lithium-ion battery cell in the battery case, wherein the lithium-ion battery cell comprises:
a positive plate;
a membrane; and
a negative plate, wherein
a plurality of positive lugs is arranged sequentially on the positive plate in a unfolded state, a plurality of negative lugs is arranged sequentially on the negative plate in a unfolded state, and
the positive plate and the negative plate are separated by the membrane and are wound to form the lithium-ion battery cell, the plurality of positive lugs forms a lug laminated structure or a lug staggered structure, and the plurality of negative lugs forms a lug laminated structure or a lug staggered structure.

18. The lithium-ion battery according to claim 17, wherein the battery case is made of aluminum.

19. The lithium-ion battery according to claim 17, wherein
the plurality of positive lugs is arranged in parallel in a direction along a length of the positive plate;
a first lug margin x₁ indicates a distance between a first positive lug and a head of the positive plate, a distance between each of the positive lugs other than the first positive lug and the head of the positive plate is indicated by d₁, with d₁=n₁w−x₁+(0.5πtΣn₁−0.5πt) or d₁=n₃w−x₁+[0.5πtΣ(n₃+1)−0.5πt];
the lithium-ion battery cell is square, and the plurality of positive lugs forms the lug laminated structure;
where t indicates a sum of thicknesses of the positive plate, the membrane and the negative plate, w indicates a width of the cell, the first positive lug is the one of the positive lugs which is located closest to the head of the positive plate, n₁ indicates that a positive lug is located at the n₁-th w on the positive plate along a direction from the head to a tail of the positive plate, and n₃ indicates that a positive lug is located at the (n₃+1)-th w on the positive plate along the direction from the head to the tail of the positive plate.

20. The lithium-ion battery according to claim 19, wherein
the plurality of negative lugs is arranged in parallel in a direction along a length of the negative plate;
a second lug margin x₂ indicates a distance between a first negative lug and a head of the negative plate, a distance between each of the negative lugs other than the first negative lug and the head of the negative plate is indicated by d₂, with d₂=n₂w−x₂+(0.5πtΣn₂−0.5πt) or d₂=n₄w+x₂+[0.5πtΣ(n₄+1)−0.5πt];
the plurality of negative lugs forms the lug laminated structure;
the first negative lug is the one of the negative lugs which is located closest to the head of the negative plate;
where n₂ indicates that a negative lug is located at the n₂-th w on the negative plate along a direction from the head to a tail of the negative plate, and n₄ indicates that a negative lug is located at the (n₄+1)-th w on the negative plate along the direction from the head to the tail of the negative plate.
